(19) United States
(12) Patent Application Publication
(10) Pub. No.: US 2005/0234569 A1
(43) Pub. Date: Oct. 20, 2005

(54) Vehicle wash control system

(75) Inventors: Karl Byrer, Denver, CO (US); Robert Knuesel, Broomfield, CO (US)

Correspondence Address: DANE C. BUTZER, 870 HIGH STREET, SUITE 104, WORTHINGTON, OH, 43085, US

(73) Assignee: Hydro-Spray, Mansfield, OH (US)

(21) Appl. No.: 11/057,619

(22) Filed: Feb. 14, 2005

Related U.S. Application Data
(60) Provisional application No. 60/563,880, filed on Apr. 19, 2004.
(60) Provisional application No. 60/565,735, filed on Apr. 27, 2004.

(51) Int. Cl. B08B 7/04; G06F 17/00; B08B 3/04; B08B 3/00

(52) U.S. Cl. 700/90; 134/18; 134/123; 134/56 R; 134/58 R; 700/237

(57) ABSTRACT

A control system for vehicle wash bays, including one or more controllers, control lines to plural wash bays, and one or more communication links to a common communication hub (e.g., an Ethernet hub) for said controllers. The controllers communicate with plural pay stations for the plural wash bays over the communication links using the common communication hub, and the controllers control the plural wash bays using the control lines responsive to communication with the pay stations. In some embodiments, a computer also communicates with the controllers and with the pay stations over the communication links using the common communication hub.

### CROSS REFERENCE TO RELATED APPLICATIONS

This application claims priority from U.S. Provisional Application No. 60/563,880, titled “Car Wash Control Mechanism and Washing System,” filed Apr. 19, 2004, in the name of inventors Karl Byrer, Craig Rosselott, and Kent Oltmann, and from U.S. Provisional Application No. 60/565,735, titled “Car Wash Control Mechanism and Washing System,” filed Apr. 27, 2004, in the name of inventors Karl Byrer, Craig Rosselott, and Kent Oltmann. Both of these applications are hereby incorporated by reference as if fully set forth herein.

### BACKGROUND OF THE INVENTION

1. Field of the Invention

This invention relates to a control system for vehicle wash facilities, for example automatic and self-serve car wash bays.

2. Description of the Related Art

Car washes with automatic and self-serve wash bays have become common. Both type of wash bays have at least a pay station where a customer pays for a wash or wash cycle and equipment for performing the selected wash or wash cycle.

In the case of an automatic wash bay, a customer selects and pays for an entire wash at the pay station for the bay and then drives his or her car (or other vehicle) into the bay. Once the car is in place, wash cycles corresponding to the selected wash are performed automatically by equipment in the bay. Once the wash is complete, the customer drives his or her car out of the bay.

In the case of a self-serve wash bay, a customer enters the bay, deposits payment for wash cycles into a pay station in the bay, selects a wash cycle (i.e., rinse, soap, foaming brush, spot free rinse, etc.), and then washes the car (or other vehicle) manually. The customer can change the wash cycle at will until the paid-for wash time expires. In addition, the customer can add additional payment to extend the duration of the wash time.

Variations on the above processes exist, although most wash bays operate substantially along these lines.

In conventional automatic and self-serve wash bays, a pay station for a wash bay directly controls wash cycles for the bay through dedicated control lines. Thus, each pay station includes a controller for its wash bay and settings for controlling wash cycles for the bay. These settings include price schedules, permitted washes (automatic) or wash cycles and times (self-serve) and the like. Some pay stations also maintain usage and payment statistics for their wash bays.

The decentralized character of this is conventional arrangement has many drawbacks. For example, in order to change prices for all wash bays at a site, each pay station's controller must be accessed and updated. This can discourage rapid responses to changing market conditions. Furthermore, usage statistics must be gathered individually from each pay station. As a result, a wash bay that is showing low usage, which might indicate some type of malfunction, could go undetected for a significant period of time. Other problems with this decentralized approach exist.

Each pay station also typically has limited computing power and limited options for setting prices, wash cycles and the like. This is particularly true of the simpler pay stations for self-serve wash bays. Even with pay stations for automatic wash bays, operators are limited to specific options built into the pay stations.

### SUMMARY OF THE INVENTION

A need exists for a control system that addresses the foregoing issues. The invention addresses these issues with a control system for vehicle wash bays that includes one or more controllers, control lines from the controllers to plural wash bays, and one or more communication links to a common communication hub for the controllers. The controllers communicate with plural pay stations for the plural wash bays over the communication links using the common communication hub. For example, the controllers can communicate with the plural pay stations for the plural wash bays to determine wash cycles ordered and paid for by customers at the pay stations. The controllers control the plural wash bays using the control lines responsive to the communication with the pay stations.

In a preferred embodiment, the controllers are programmable logic controllers (PLCs), and the control lines include lines for activating individual wash bay functions. For example, the wash bay functions can be activated through individual valves and switches attached to the control lines at each of the wash bays.

The wash bays can include self-serve wash bays, automatic wash bays, or both self-serve and automatic wash bays. Because of the simpler nature of the operation of self-serve wash bays, plural of the self-serve wash bays preferably are controlled by a common controller. If more self-serve bays are present than can be handled by one controller, one or more additional common controllers can be used for those bays. For example, twelve self-serve bays could be controlled by two controllers. The automatic wash bays are more complex, so each of the automatic wash bays preferably is controlled by its own controller.

In a preferred embodiment, the communication links include one or more Ethernet links and the common communication hub includes an Ethernet hub.

A computer can be hooked up to the communication hub to communicate with the controllers and with the pay stations over the communication links. This arrangement permits centralized control of the wash bays and pay stations. Prices, wash cycles, wash times and the like preferably can be set and usage statistics can be gathered by the computer, thereby providing greater flexibility and awareness to an operator. For example, the computer can be used to control and to modify prices, wash cycles, wash times and the like automatically or remotely, possibly based on one or more of a customer's identity (e.g., through a “frequent washer” program), customer usage, customer volume, time of day (e.g., “happy hours”), day of week, season, cost of water, status of wash supplies, and environmental conditions. Any other schemes programmed into the computer can be implemented and propagated to the pay stations and the controllers with relative ease.

Furthermore, the pay stations can report operational status to the computer, the controllers, or both the computer and the controllers through the common communication hub. Likewise, the controllers can report operational status to the computer. The operational status can include, for example, usage statistics for wash cycles, information about one or more errors, faults, failures and use of backup or redundant equipment by the pay stations and wash bays, and other status information. The computer can report the operational status to an operator.

The invention also encompasses methods of using the foregoing arrangements, as well as other embodiments such as programs for executing those methods.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a block diagram of a control system for vehicle wash bays according to the invention.

FIG. 2 shows an example of one possible arrangement for a pay station for an automatic wash bay.

FIG. 3 shows an example of one possible arrangement for a pay station for a self-serve wash bay.

FIG. 4 illustrates a possible operational sequence for a customer to use an automatic wash bay controlled according to the invention.

FIG. 5 illustrates a possible operational sequence for a customer to use a self-serve wash bay controlled according to the invention.

### DESCRIPTION OF THE PREFERRED EMBODIMENT

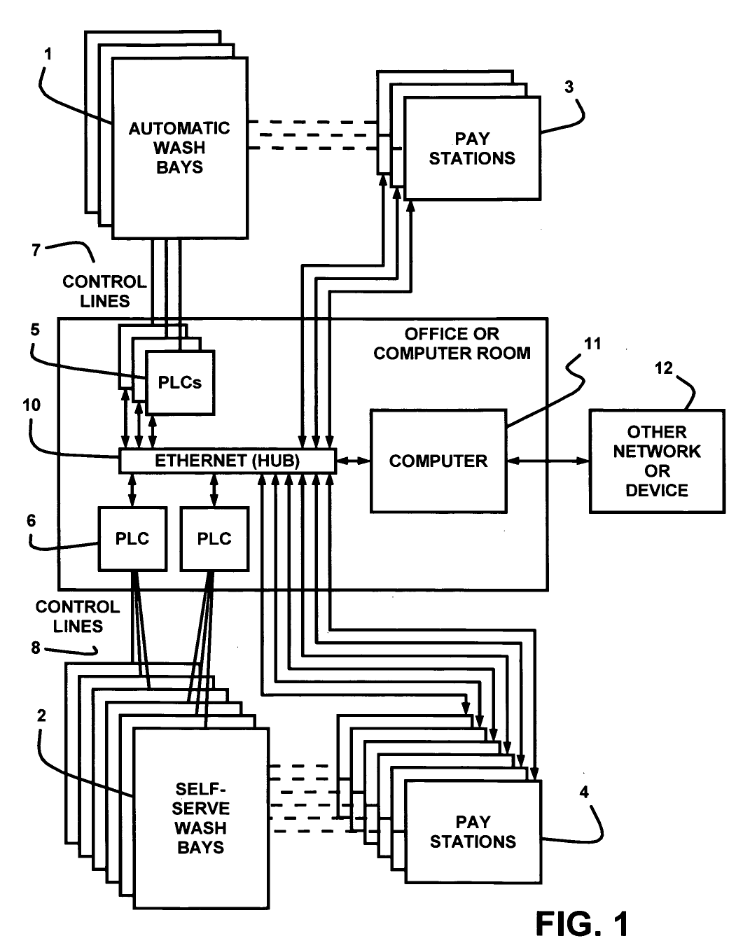

FIG. 1 shows a block diagram of a control system for vehicle wash bays according to the invention.

Briefly, one aspect of the invention is a control system for vehicle wash bays that includes one or more controllers, control lines from the controllers to plural wash bays, and one or more communication links to a common communication hub for the controllers. The controllers communicate with plural pay stations for the plural wash bays over the communication links using the common communication hub. For example, the controllers can communicate with the plural pay stations for the plural wash bays to determine wash cycles ordered and paid for by customers at the pay stations. The controllers control the plural wash bays using the control lines responsive to the communication with the pay stations.

FIG. 1 shows plural automatic wash bays 1 and self-serve wash bays 2. More self-serve wash bays are shown than automatic wash bays. While this is a common arrangement, the invention is equally applicable to any combination of automatic and self-serve wash bays, including one wash bay or a set of all one type of wash bays.

Pay stations 3 and 4 are associated with each wash bay in FIG. 1, as indicated by dashed lines. Typically, one pay station is provided for each wash bay, although this need not be the case.

In conventional systems, each pay station would have control lines to each wash by to control operation of that wash bay. That arrangement has significant drawbacks as discussed above.

According to the invention, the wash bays are controlled by controllers 5 and 6 via control lines 7 and 8. In FIG. 1, the controllers are programmable logic controllers (PLCs), and the control lines include lines for activating individual wash bay functions. For example, the wash bay functions can be activated through individual valves and switches attached to the control lines at each of the wash bays. Other types of controllers besides PLCs and other types of control lines and control line arrangements can be used without departing from the invention.

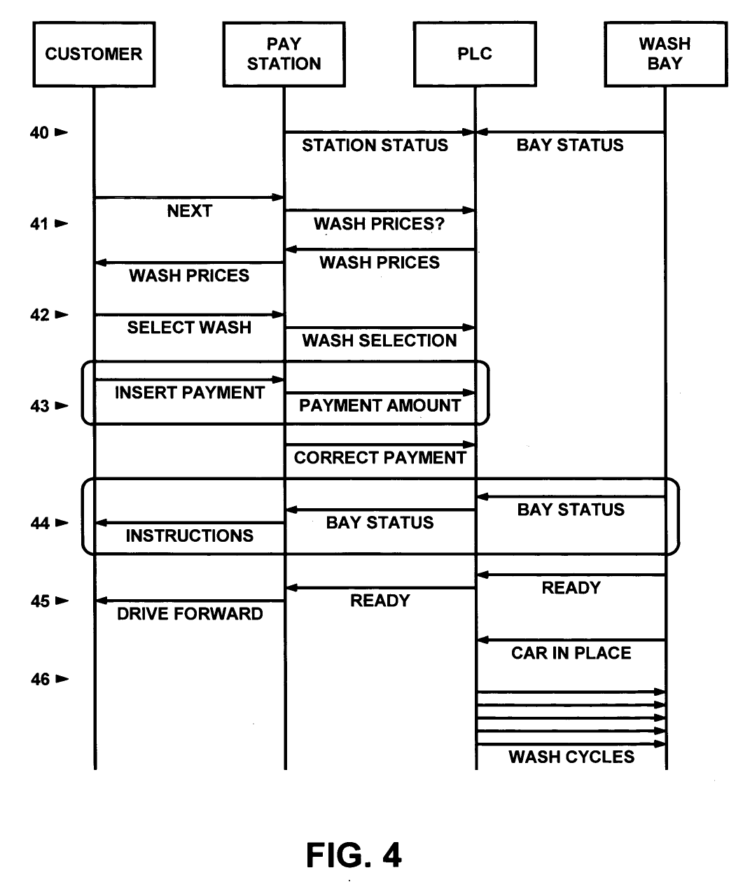

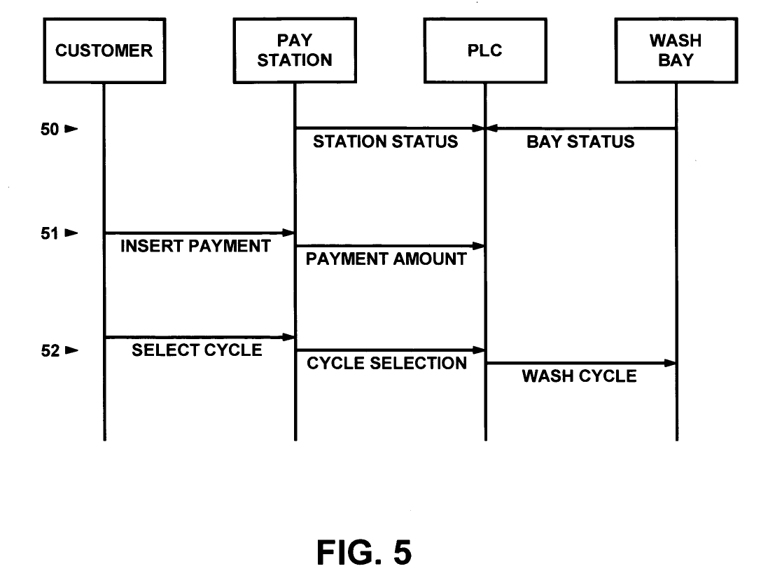

In the depicted embodiment, each automatic wash bay has its own controller 5, whereas plural self-serve wash bays share a common controller 6. More than one such common controller can be present. For example, each controller could control six self-serve wash bays, and two such controllers could be present. A single controller can be used for several self-serve wash bays because of the simpler operations needed to control those bays, as illustrated by the discussions of FIGS. 4 and 5 below.

In other embodiments, one controller could be used for each bay regardless of type, one controller could be used for some combination of automatic and self-serve wash bays, or one controller could be used for all wash bays at a site. Other arrangements of controllers and wash bays are possible without departing from the invention.

The controllers and pay stations interact via communication links, shown as two-headed arrows in FIG. 1, through a common communication hub 10. In a preferred embodiment, the communication links include one or more Ethernet links and the common communication hub is or includes an Ethernet hub, although this need not be the case. Thus, a pay station 3 or 4 communicates with a controller 5 or 6 (e.g., a PLC) through common communication hub 10, and the controller in turn controls the corresponding wash bay 1 or 2 accordingly through control lines 7 or 8. This arrangement is different from conventional prior-art systems, in which a pay station directly controls a corresponding wash bay's operation, for example through dedicated control lines.

In a preferred embodiment, computer 11 is connected to common communication hub 10 to communicate with pay stations 3 and 4 and controllers 5 and 6 over the communication links. This arrangement permits centralized control of the wash bays and pay stations. Prices, wash cycles, wash times and the like preferably can be set and usage statistics can be gathered by the computer, thereby providing greater flexibility and awareness to an operator.

For example, the computer can be used to control and to modify prices, wash cycles, wash times and the like automatically or remotely, possibly based on one or more of a customer's identity (e.g., through a “frequent washer” program), customer usage, customer volume, time of day (e.g., “happy hours”), day of week, season, cost of water, status of wash supplies, and environmental conditions. Automatic modification could be used to implement happy hours, to provide extra time to “frequent washers” detected through a swipe of a “frequent washer” card though the credit card acceptor and the like. Remote modification could be used to raise or to lower prices, to lengthen or to shorten wash cycles, to change automatic modification programs and the like. Any other schemes programmed into the computer can be implemented and propagated to the pay stations and the controllers with relative ease.

Furthermore, the pay stations can report operational status to the computer, the controllers, or both the computer and the controllers through the common communication hub. Likewise, the controllers can report operational status to the computer. The operational status can include, for example, usage statistics for wash cycles, information about one or more errors, faults, failures and use of backup or redundant equipment by the pay stations and wash bays, and other status information. The computer can report the operational status to an operator.

The computer can be connected to other networks or devices 12. For example, computer 10 could be connected to the Internet, another computer, a wireless router or switch, or the like. If computer 11 is connected to other networks or devices 12, the connection preferably is protected with suitable security and encryption.

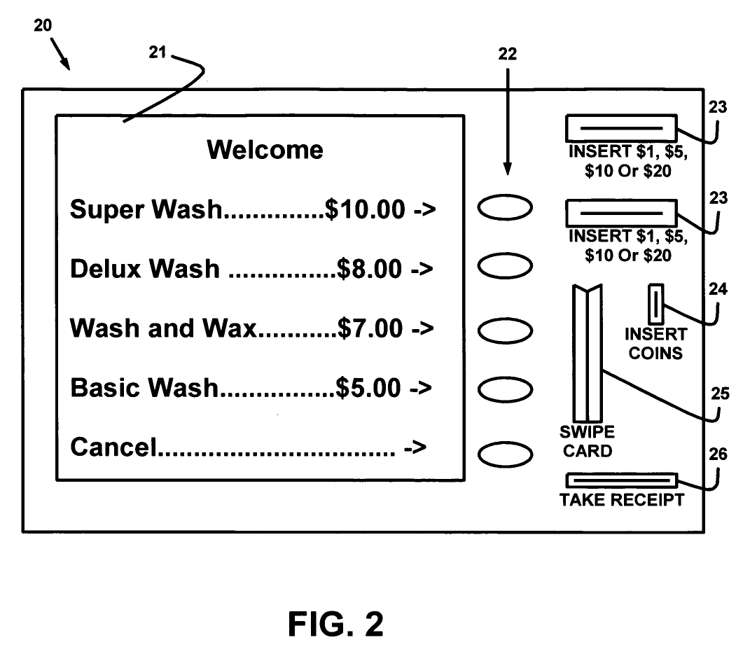

FIG. 2 shows an example of one possible arrangement for a pay station for an automatic wash bay. Pay station 20 includes display 21 such as a CRT or LCD screen, buttons 22, bill acceptors 23, coin acceptor 24, credit card acceptor 25, which preferably also can be used to read a “frequent washer” card from a customer, and receipt dispenser 26. Buttons 22 are disposed for choosing from selections shown on display 21. In an alternative embodiment, display 21 is a touch screen.

The pay station preferably is programmed to display different screens on display 21 that guide a user through operation of the pay station. Examples of such screens can include, but are not limited to, promotional screens, “frequent washer” screens, payment type (e.g., cash, credit, or prepaid) selection screens, wash description screens, wash selection screens and the like. Other screens showing other information and selections can be used.

Pay station 20 preferably includes redundant components for elements that are more likely to break down. In particular, bill acceptors are prone to break-down, which can take an entire pay station and therefore an entire wash bay out of commission. Thus, FIG. 2 shows redundant bill acceptors 23.

In other embodiments, redundant components might be included for no elements or for other elements.

In a preferred embodiment, pay stations for self-serve wash bays are similar to the automatic wash bay pay station discussed above. In fact, the same hardware can be used, only programmed to show some different screens that correspond to self-serve operations. Thus, examples of screens shown by a self-serve wash bay pay station can include, but are not limited to, promotional screens, “frequent washer” screens, payment type (e.g., cash, credit, or prepaid) selection screens, time versus payment selection screens, time remaining screens and the like. Other screens showing other information and selections can be used.

Alternatively, hardware specifically tailored to a self-serve wash bay can be used.

With both types of pay stations, the functionality of the pay station is at least partially dependent upon the screens and information shown on the pay station's display. According to the invention, the pay stations communicate with a central communication hub (e.g., Ethernet hub 10 in FIG. 1), which in turn can communicate with outside devices. This combination of elements permits remote control and modification of the screens and operation of the pay stations.

As discussed above, the same or similar hardware preferably is used for both types of pay stations. This standardization of hardware helps to keep maintenance and repair costs down.

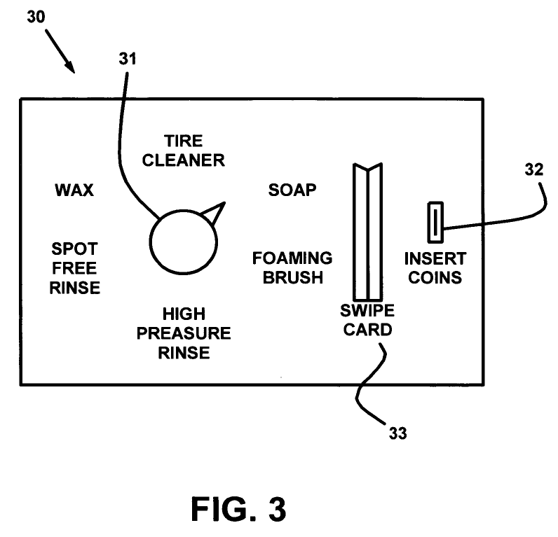

Alternatively, a pay station for a self-serve wash bay could use a more traditional looking interface such as the one shown in FIG. 3. In that figure, pay station 30 includes selector 31, coin acceptor 32 and credit card acceptor 33. Acceptor 31 is used to select a wash cycle, examples of which are shown in FIG. 3. The invention is not limited to these wash cycles. Coin acceptor 32 and credit card acceptor 33 can be used to pay for wash cycles. In different embodiments, any combination of coin acceptor, bill acceptor (not shown) and credit card acceptor can be present, as well as other elements.

Even with the more traditional looking interface, certain operations are amendable to automatic or remote control and modification according to the invention. In fact, nearly all of the possible automatic and remote modification of pricing, wash times, wash cycles and the like possible with other pay stations are still possible with the more traditional looking self serve pay station interface.

The invention is not limited to pay stations of the types shown in FIGS. 2 and 3. Any other types of pay stations can be used.

FIG. 4 illustrates a possible operational sequence for a customer to use an automatic wash bay controlled according to the invention. All communication in FIG. 4 between the illustrated pay station, PLC, and wash bay occur over common communication hub 10 as shown in FIG. 1.

Operations 40 include the following steps: a pay station and its associated wash bay transmit status information to a PLC. These steps preferably occur periodically or continuously.

Operations 41 include the following steps: (1) a customer presses a button or otherwise indicates a desire to proceed; (2) the pay station requests wash prices from the PLC; (3) the PLC responds with the wash prices; and (4) the pay station displays wash options and prices to the customer.

Operations 42 include the following steps: (1) the customer selects a wash (e.g., super, deluxe, wash and wax, or basic—the invention is not limited to these selections); and (2) the pay station transmits the wash selection to the PLC.

Operations 43 include the following steps: (1) the customer inserts payment (either cash or credit) into the pay station; and (2) the pay station informs the PLC of the payment. These steps can form a loop that is repeated until correct payment for the selected wash is received. Operations 43 also can include an explicit indication from the pay station that correct payment has been received.

Operations 44 include the following steps: (1) the PLC receives status information from the wash bay that indicates the wash bay's current status (for example, that the wash bay is busy with another customer's vehicle); (2) the PLC reports this status to the pay station; and (3) the pay station provides suitable instructions to the customer, for example “please wait.” These steps can form a loop that is repeated until the wash bay is ready for the customer's vehicle.

Operations 45 include the following steps: (1) the PLC receives status information from the wash bay that indicates that the wash bay is ready to wash a vehicle (for example, the wash bay could report that a previous customer's wash is over and that the previous customer has driven his or her vehicle out of the wash bay); (2) the PLC reports the “ready” status to the pay station; and (3) the pay station provides suitable instructions to the customer, for example “please proceed” or “please drive forward.”

Operations 46 include the following steps: (1) the PLC receives an indication from the wash bay that the customer's vehicle is in place; (2) the PLC controls the wash bay to perform wash cycles corresponding to the wash that the customer selected.

These operations are not necessarily performed in the order shown. For example, some operations and steps might be performed at the same time or in other orders. In addition, some operations and steps might be skipped, and other different operations and steps might be used.

FIG. 5 illustrates a possible operational sequence for a customer to use a self-serve wash bay controlled according to the invention.

Operations 50 include the following steps: a pay station and its associated wash bay transmit status information to a PLC. These steps preferably occur periodically or continuously.

Operations 51 include the following steps: (1) a customer inserts payment into the pay station; and (2) the pay station reports the amount of payment to the PLC. The PLC in turn determines a wash time corresponding to the payment amount.

In a preferred embodiment, a remaining wash time is displayed to a customer, for example through a display of the type shown in FIG. 2. In embodiments that use such a display, the display also could show a screen of payment versus time options before and after the customer inserts payment. Alternatively, no display or another type of display such as a simple LED counter could be used.

Operations 52 include the following steps: (1) the customer selects a wash cycle through the pay station; (2) the pay station reports the cycle selection to the PLC; and (3) the PLC controls the wash bay to perform the wash cycles (e.g., soap, foaming brush, high pressure rinse, spot free rinse, wax, or tire cleaner—the invention is not limited to these cycles) as long as the customer has wash time remaining.

Preferably, operations 50, 51 and 52 occur continuously and simultaneously. Other operations and steps, as well as other orderings of those operations and steps, can be used.

The invention is not limited to the operational sequences shown in FIGS. 4 and 5. Rather, the invention can be used to facilitate any operational sequences for interactions between pay stations and wash bays.

### Alternative Embodiments

The invention is in no way limited to the specifics of any particular preferred embodiment and examples disclosed herein. In particular, not all embodiments of the invention include all of the features discussed above. For example, features described in permissive terms (i.e., “can”) may or may not be present in some embodiments of the invention. Many variations are possible which remain within the content, scope and spirit of the invention, and these variations would become clear to those skilled in the art after perusal of this application.

1. A control system for vehicle wash bays, comprising:
one or more controllers;
control lines from the controllers to plural wash bays; and
one or more communication links to a common communication hub for said controllers;
wherein said controllers communicate with plural pay stations for said plural wash bays over said communication links using said common communication hub, and said controllers control said plural wash bays using said control lines responsive to communication with said pay stations.

2. A control system as in claim 1, wherein said controllers are programmable logic controllers.

3. A control system as in claim 1, wherein said control lines include lines for activating individual wash bay functions.

4. A control system as in claim 3, wherein said individual wash bay functions are activated through individual valves and switches at each of said wash bays.

5. A control system as in claim 1, wherein said wash bays include self-serve wash bays, automatic wash bays, or both self-serve and automatic wash bays.

6. A control system as in claim 5, wherein plural of said self-serve wash bays are controlled by a common controller, and wherein each of said automatic wash bays is controlled by its own controller.

7. A control system as in claim 1, wherein said communication links include one or more Ethernet links and said common communication hub includes an Ethernet hub.

8. A control system as in claim 1, wherein said controllers communicate with said plural pay stations for said plural wash bays to determine wash cycles ordered and paid for by customers at said pay stations.

9. A control system as in claim 1, wherein a computer communicates with said controllers and with said pay stations over said communication links using said common communication hub.

10. A control system as in claim 9, wherein said computer communicates with said controllers and said pay stations to set prices and wash cycles for said wash bays.

11. A control system as in claim 10, wherein said computer, said controllers, or both said computer and said controllers can be programmed to automatically change said prices and said wash cycles.

12. A control system as in claim 11, wherein said prices and said wash cycles are changed automatically based on one or more of a customer's identity, customer usage, customer volume, time of day, day of week, season, cost of water, status of wash supplies, and environmental conditions.

13. A control system as in claim 9, wherein said pay stations report operational status to said computer, said controllers, or both said computer and said controllers.

14. A control system as in claim 13, wherein said operational status includes usage statistics for said wash cycles.

15. A control system as in claim 13, wherein said operational status includes information about one or more of faults, errors, failures, and use of backup or redundant pay station systems by said pay stations.

16. A control system as in claim 13, wherein said computer reports said operational status to an operator.

17. A method of controlling vehicle wash bays, comprising:
communicating, by plural controllers, with plural pay stations for plural wash bays over one or more communication links using a common communication hub; and
controlling, by said plural controllers, said plural wash bays using control lines responsive to communication with said plural pay stations.

18. A method as in claim 17, wherein said controllers are programmable logic controllers.

19. A method as in claim 17, wherein said control lines include lines for activating individual wash bay functions.

20. A method as in claim 19, wherein said individual wash bay functions are activated through individual valves and switches at each of said wash bays.

21. A method as in claim 17, wherein said wash bays include self-serve wash bays, automatic wash bays, or both self-serve and automatic wash bays.

22. A method as in claim 21, wherein plural of said self-serve wash bays are controlled by a common controller, and wherein each of said automatic wash bays is controlled by its own controller.

23. A method as in claim 17, wherein said communication links include one or more Ethernet links and said common communication hub includes an Ethernet hub.

24. A method as in claim 17, wherein said controllers communicate with said plural pay stations for said plural wash bays to determine wash cycles ordered and paid for by customers at said pay stations.

25. A method as in claim 17, wherein a computer communicates with said controllers and with said pay stations over said communication links using said common communication hub.

26. A method as in claim 25, wherein said computer communicates with said controllers and said pay stations to set prices and wash cycles for said wash bays.

27. A method as in claim 26, wherein said computer, said controllers, or both said computer and said controllers can be programmed to automatically change said prices and said wash cycles.

28. A method as in claim 27, wherein said prices and said wash cycles are changed automatically based on one or more of a customer's identity, customer usage, customer volume, time of day, day of week, season, cost of water, status of wash supplies, and environmental conditions.

29. A method as in claim 25, wherein said pay stations report operational status to said computer, said controllers, or both said computer and said controllers.

30. A method as in claim 29, wherein said operational status includes usage statistics for said wash cycles.

31. A method as in claim 29, wherein said operational status includes information about one or more of faults, errors, failures, and use of backup or redundant pay station systems by said pay stations.

32. A method as in claim 29, wherein said computer reports said operational status to an operator.
